(19) United States
(12) Patent Application Publication
(10) Pub. No.: US 2011/0187647 A1
(43) Pub. Date: Aug. 4, 2011

(54) Method and apparatus for virtual keyboard interactions from secondary surfaces

(76) Inventors: Charles Howard Woloszynski, Vienna, VA (US); Taylor Duong Woloszynski, Vienna, VA (US); Samantha Duong Woloszynski, Vienna, VA (US)

(21) Appl. No.: 12/658,160

(22) Filed: Feb. 4, 2010

(51) Int. Cl. G06F 3/041; G06F 3/02

(52) U.S. Cl. 345/168; 345/173

(57) ABSTRACT

A method and apparatus for user input on a handheld device with a virtual keyboard using secondary surfaces. On the primary surface of the device (e.g., front), the user interacts via touch sensors and a display element. Secondary surfaces (e.g., back) include additional touch sensors through which the user can also provide input. The display element is used to present information appropriate to the device's function (e.g., email messages) and control elements, including a virtual keyboard. The user interacts with the touch sensors on the first surface to bring up the virtual keyboard. Once displayed, the user can interact with this keyboard using either the primary surface or secondary surfaces. When used on appropriately sized device, the user can hold the device with the palms and thumbs of both hands and use their fingers on the touch sensors on the secondary surfaces to type. The selection of a key on the virtual keyboard is accomplished the combination of contacts made on the touch sensors on the secondary surfaces. The selected key, or region of the keyboard, is visually indicated on the front surface. Input of the keystroke is recorded when the user removes their touch from certain touch sensors on the secondary surfaces.

### BACKGROUND

The invention relates generally to user input for computer systems and more particularly to efficient data input into handheld devices. An emerging class of handheld devices use a display element to present a virtual keyboard to the user for input. The user touches the display to enter data on this keyboard. This input method allows changes in the keyboard design without requiring changes in the physical device. However, this approach limits the rate of input based on the speed and accuracy of the user's touches and the system to sense these inputs. The first generation of these platforms are the Apple iPhone, iPod Touch, and Motorola Droid (iPod and iPhone are trademarks of Apple, Inc, and Droid is a trademark of Motorola). A second generation of handheld devices, generically referred to as tablet computers, have recently been released, including the Apple iPad (iPad is a trademark of Apple, Inc). These devices are larger than the first generation and allow for more conveniently holding the device with two hands.

The user expects to be able to input data into these devices while holding it. For example, a user may want to enter notes from a lecture or a meeting on this device. If the user holds the device in portrait mode and calls up a keyboard to enter data, the user could use a thumb typing and reach across the screen. If the user is in landscape mode, the virtual keyboard may need to split to allow the user to use thumb typing since the distance across the device in landscape mode may exceed the user's reach with their thumbs. If a virtual keyboard is the full width of the screen in landscape mode, the user will need to use two hands to type effectively and will need to rest the device on something.

Another approach to typing on these devices is to use the back of the device as a touch sensitive surface that acts as if touches on the back correspond to touches on the front (See USPTO Patent Application 20070103454). If the locations of the touches on the back of the unit have a one-to-one correspondence with the keys on the virtual keyboard, the user will have to accurately position their hands for each individual key. This is difficult to accomplish for the average user.

Other approaches may use add-on keyboards (e.g., bluetooth keyboard), but they suffer all the problems of physical keyboards. In a handheld device, the ergonomics of viewing the screen while typing becomes problematic. A stand could be used, but this adds additional components for using this portable device. Likewise, the addition of an external keyboard makes using this portable device cumbersome. A slide-out keyboard now makes the device larger and more prone to failure and limits the orientations that the device can be used in. Both external keyboards and slide-out keyboards limit the availability of unique virtual keyboard layouts for various software applications.

### SUMMARY

In one embodiment the invention provides a method to interact with a virtual keyboard while holding the device with both hands and using touch input on secondary surfaces to select keys. The touch input on the secondary surfaces does not require highly accurate placement of the fingers to reach distinct locations for each key. Instead, the touch input requires combinations of touch patterns to represent the various keystrokes. The system can provide visual feedback to the user to allow them to discover the right pattern for each keystroke. The system supports the use of customized keyboard layouts with a consistent method for identifying keystrokes.

### BRIEF DESCRIPTION OF THE DRAWINGS

FIG. 1 shows a front view of a prior art handheld device.

FIG. 2 shows an embodiment of a handheld device in accordance with the invention.

FIG. 3 shows another embodiment of a handheld device in accordance with the invention wherein multiple sensor areas are provided.

FIG. 4 shows a virtual keyboard and three zones the user selects using two touch areas.

FIG. 5 show the left zone of a virtual keyboard as controlled by the user for column selection.

FIG. 6 show the middle zone of a virtual keyboard as controlled by the user for column selection.

FIG. 7 show the left zone of a virtual keyboard as controlled by the user for row selection.

FIG. 8 shows the touch sensors involved with calibrating the position of L1, L2, L3, and R1, R2, R3 relative to the user's grasp of the device.

FIGS. 9A, 9B, and 9C show a view from above of three possible embodiments of the handheld device in accordance with the invention, illustrating possible placements of secondary surfaces on the device.

### DETAILED DESCRIPTION

The following description is presented to enable any person skilled in the art to make and use the invention as claimed and is provided in the context of the particular examples discussed below, variations of which will be readily apparent to those skilled in the art. Accordingly, the claims appended hereto are not intended to be limited by the disclosed embodiments, but are to be accorded their widest scope consistent with the principles and features disclosed herein.

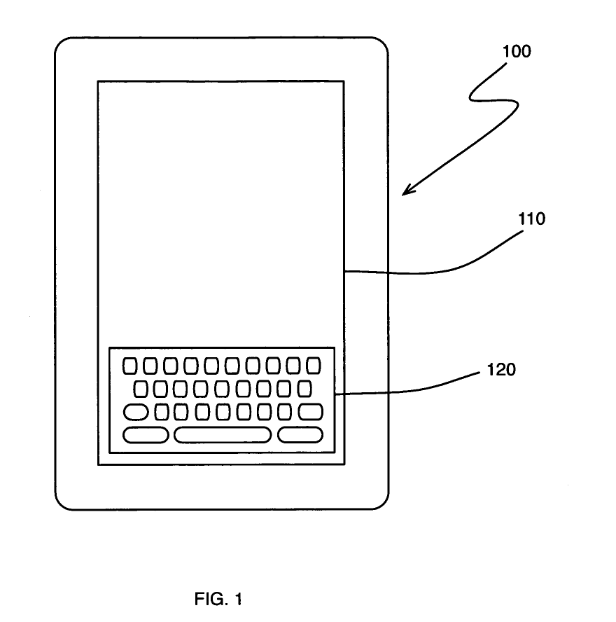

Small multi-media handheld devices with touch screens such as mobile telephones and tablet computers typically use a virtual keyboard for user input. A device can have many virtual keyboard layouts to assist in a variety of data entry tasks. An illustrative prior part device that is laid out in this manner is the iPad from Apple, Inc. As shown in FIG. 1, the main face of the iPad 100 comprises of a touch-sensitive LCD 110. Within this display element, a virtual keyboard 120 is illustrated.

In contrast, a multi-media handheld device in accordance with the invention include additional touch sensors on secondary surfaces. More specifically, touch-sensitive sensors are provided on surfaces on the device that can be interacted with while holding the device. These sensors are used to augment the input accomplished by the touch sensors on the display element. When the device is activated or placed into an operational state where it is appropriate, control elements (e.g. soft keys and menus) are displayed on the display element. Prior art devices would require the user to touch the display element to indicate their input. This can be awkward to use the entire keyboard and simultaneously hold the device.

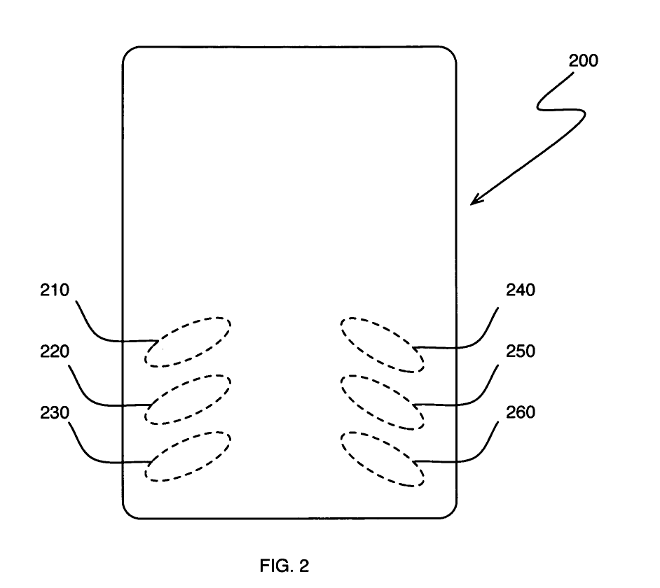

Referring to FIG. 2, a view of the back of multi-media handheld device 200 in accordance with one embodiment of the invention includes six touch-sensitive areas, 210, 220, 230, 240, 250 and 260. As used herein, these six touch-sensitive areas may be created using several technologies. These may include discrete capacitive touch detectors, discrete pressure switches, or a touch-sensitive surface that is adapted to simultaneously detect where one or more object touch it (e.g., fingers) and the effects those objects create on the sensors. The location of these touch sensitive areas L1, L2, L3, R1, R2, R3 may be in fixed positions, or they may be adjustable. The location of these touch-sensitive areas may be physically marked on the outside of the case or may be unmarked. The marking may be accomplished in a variety of manners, including using indentations or raised markers.

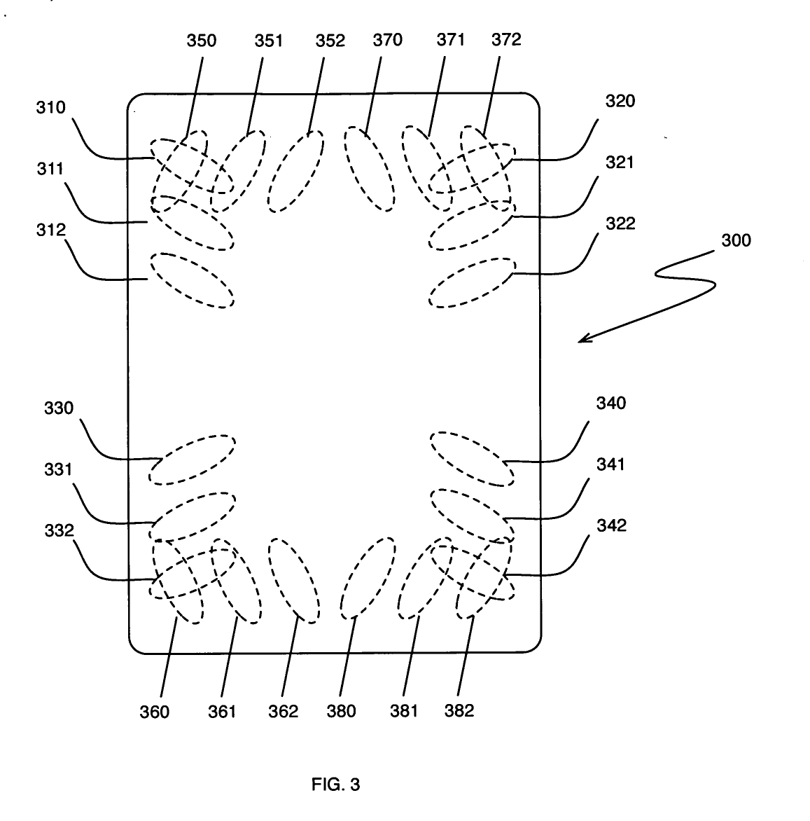

Referring to FIG. 3, a view of the back of multi-media handheld device 300 in accordance with one embodiment of the invention includes twenty-four touch-sensitive areas for use in four orientations. The areas for portrait use 330, 331, 332, 340, 341, 342 correspond to the areas 210, 220, 230, and 240 in the FIG. 2. Additional touch-sensitive areas 310, 311, 312, 320, 321, 322, and 323 are added to allow the device to be used in portrait mode when inverted. To use the device in landscape mode, touch-sensitive locations are added in 350, 351, 352, 360, 361, and 362 as well as at 370, 371, 372, 380, 381, 382. In this embodiment, some touch sensitive locations overlap. The unit 300 may include a sensor to detect the orientation of the device to determine how to interpret touches at these overlapping locations. For example, if the device is in landscape mode, a touch in the area of 372 and 320 could be considered a touch at location 372 to better reflect the overall situation and likely intent of the user. The overlap of touch-sensitive areas in 300 make the use of a touch sensitive surface a practical implementation for the sensors.

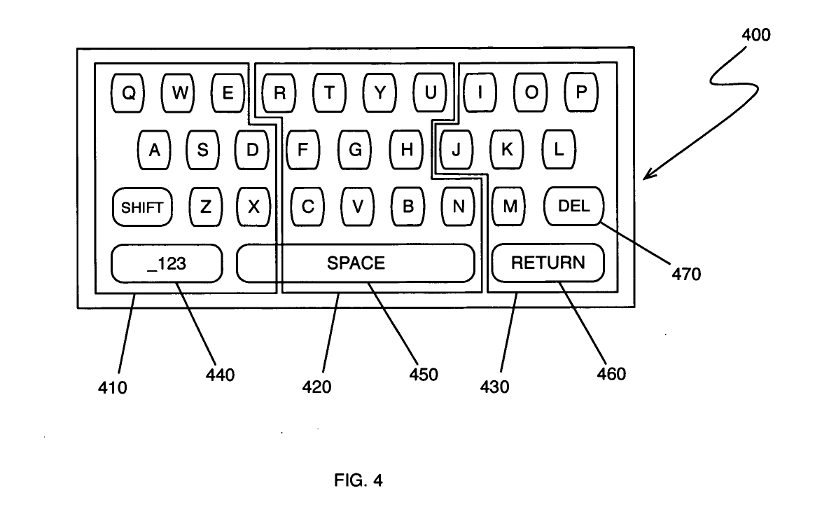

Referring to FIG. 4, the virtual keyboard on the display element is illustrated with additional divisions 410, 420 and 430, referred to as zones. This keyboard layout is for inputting the Roman alphabet, but the invention is not limited to this alphabet or keyboard layout. The invention allows for application to any virtual keyboard layout that can be divided into up to three zones and have up to 16 keys in each zone, when using only 6 touch sensitive areas. The addition of two additional touch sensitive areas, using all four fingers, can expand the addressable number of keys in any keyboard as a natural variation of this invention to those skilled in the art. The user interacts with one embodiment of the device 100 through its touch-sensitive display element 110 to bring up a virtual keyboard 120. The virtual keyboard, extended to support the concept of input from secondary surfaces and the selection of zones of the keyboard, controls the zone boundaries for each particular keyboard layout within the constraints of no more than 16 keys per zone. The zones are not required to be precisely square. In fact, most keyboard layouts have a natural staggered key design and the invention can easily accommodate this, as shown in zones 410, 420, and 430. Zone 410 has four rows. If the key 440 (numeric keyboard) is considered to cover two key spaces, then each column in zone 410 has three columns. Similarly, zone 420 has four rows. The first and third row have four columns; the second row has three columns, and the final row can be considered to have four columns which all map to the same key 450. In zone 430, if the key 470 is considered to cover two key spaces and key 460 covers three key spaces, then the zone can be considered to have four rows with three columns. In embodiments with different keyboard layouts, those skilled in the art could easily apply this invention to determine appropriate zone boundaries, and row and column assignments for each key.

Once in the state to accept keyboard input, the user can use finger touches on the secondary surfaces to select keys for input. The touch sensitive areas are assigned symbolic names L1, L2, L3, R1, R2, and R3. One embodiment 200 for this may associate touch areas 210, 220, 230, 240, 250, and 260 with R1, R2, and R3 and L1, L2, and L3. These associations can be controlled by software to meet various users preferences. For the following discussion, specific mappings will be used, but other mappings are within the scope of this invention. Touches to 200, 210, 220, 230, 240, 250, and 260 will be mapped to R1, R2, R3, L1, L2, L3 respectively, for this discussion. The invention uses L1 and R1 to select the zone of the keyboard 400. Touch on L1 is used to indicate that the user wants to select a key in zone 410. Touch on R1 is used to indicate that the user wants to select a key in zone 430. Touching both L1 and R1 indicates that the user wants to select a key from zone 420. No zone or key selection is made if the user does not touch either L1 or R1. If the number of keys in virtual keyboard is sufficiently small, it may be made of only two zones, each selected by pressing individually L1 or R1. To allow the user to learn the required touches, the virtual keyboard 400 can react to touches by highlighting the selected zone. For example, if a user touched L1, one embodiment would highlight zone 410. In other embodiments, the zone 410 could be highlighted and the other zones 420 and 430 could be dimmed. In other embodiments, zone 410 could be left unaltered and the other zones could be dimmed. This highlighting or dimming is generally indicating the user's selected area of focus. Likewise, if the user touched R1, in one embodiment zone 430 could indicate the user's focus and if both L1 and R1 are touched, the zone 420 could indicate the user's focus. If L1 is pressed and then R1 is pressed, the user might be shown initially the focus on 410 and then the focus indication would shift to zone 420.

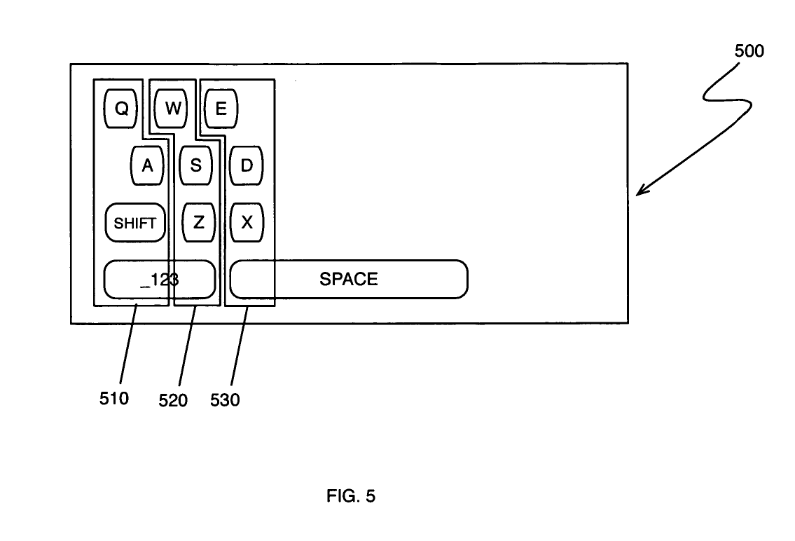

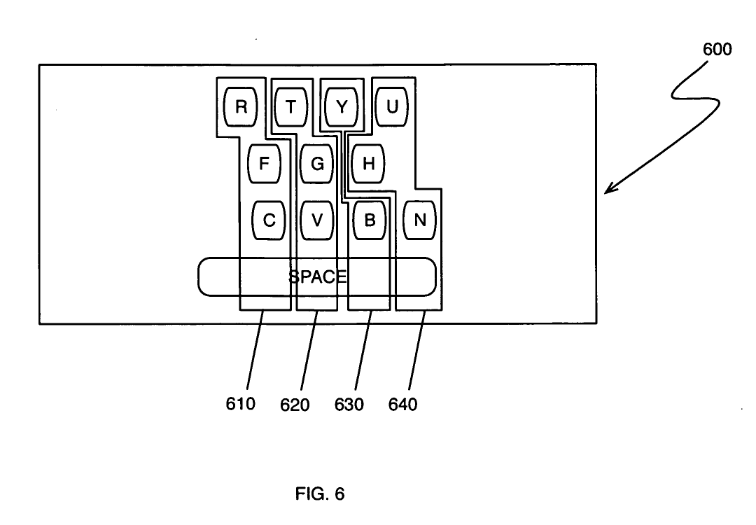

Once a zone has been selected, the virtual keyboard indicates to the user the selected row and column based on the state of L2, R2 and L3, R3. In FIG. 5, the left portion of the virtual keyboard is shown. In accordance with the invention, L2 and R2 select the column within the selected zone. In one embodiment, the virtual keyboard indicates the selected column to assist the user in learning the touches to select a specific key. Touching neither L2 nor R2 will select the middle column 520. Touching L2 only will select the left column 510. Touching R2 only will select the right column 530. Touching both may be ignored, effectively touching neither. This results in selecting the middle column 520. As the user changes their touches, the virtual keyboard 500 can animate their changing selections to assist the user in understanding the impact each touch has on the selection. FIG. 6. shows a keyboard with four columns instead of the three shown in FIG. 5. The behavior of the effect on touches to the selection of columns is equivalent to that in FIG. 5, with an extended meaning of touching both L2 and R2. Touching neither L2 nor R2 will select the left-middle column 620. Touching L2 only will select the left column 610, effectively shifting the selection one to the left. Touching R2 only will select the right column 640, effectively shifting the selection two to the right. Touching both select the right-middle column 630. This is consistent with the meaning of L2 moving the selection one to the left and R2 moving the selection two to the right. Selecting both causes both actions, with a combined effect of moving the selection one to the right. As the user changes their touches, the virtual keyboard can animate their changing selections to assist the user in understanding the impact each touch has on the selection.

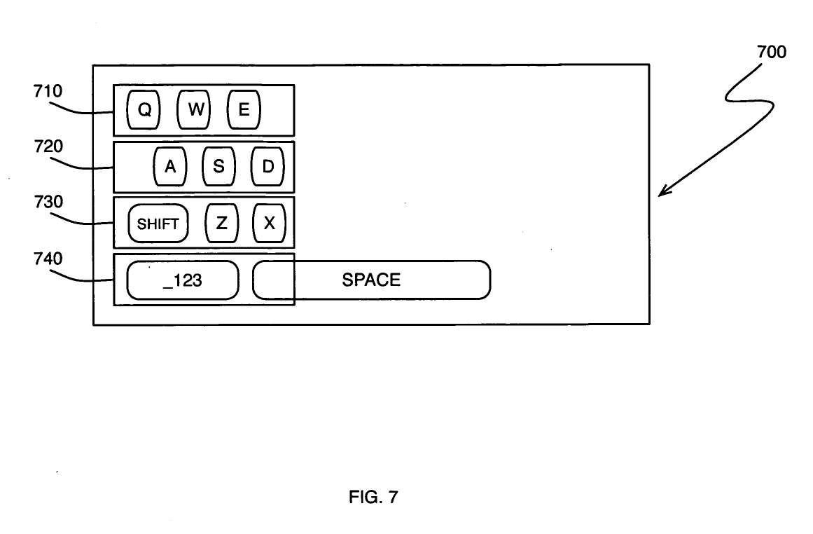

Referring to FIG. 7, the left zone of the virtual keyboard is shown. In accordance with the invention, L3 and R3 select the row within the selected zone. When the selected zone has four rows, the following behavior is performed. Touching neither L3 nor R3 will select the upper-middle row 720. Touching L3 only will select the top row 710, effectively shifting the selection one up. Touching R3 only will select the bottom row 740, effectively shifting the selection two down. Touching both select the lower-middle row 730. This is consistent with the meaning of L3 moving the selection one up and R3 moving the selection two down. Selecting both causes both actions, with a combined effect of moving the selection one down. As the user changes their touches, the virtual keyboard can animate their changing selections to assist the user in understanding the impact each touch has on the selection.

When the selected zone has three rows, the following behavior is performed. Touching neither L3 nor R3 will select the middle row 720. Touching L3 only will select the top row 710. Touching R3 only will select the bottom row 740.

After the user selects a zone, the invention always has a row and column selected. In some embodiments, this is visually indicated to the user. The intersection of these selections selects the place where the effective touch will be generated on the virtual keyboard. As the user changes the selection, the effective touch changes. The virtual keyboard can react to this. Prior art devices such as the Apple iPhone highlight the key being selected with a touch. Moving the point of contact while still holding the finger down allows the selection to change without generating the actual keystroke. The keystroke is generated upon release of the touch. For the invention, the keystroke is generated when the prior touch to at least L1 and R1 are released. The user can move between zones without causing a keystroke by maintaining at least one finger on either L1 or R1. So, a user can start with a touch on L1, then add R1, then release L1 to move the zone selection from the left to the right, as needed. Once the rest of the key selection is completed, the user can release R1 to generate the desired keystroke. Other variations of this invention may require the user to release all touches on L1, L2, L3, R1, R2, and R3 or other subsets before generating a keystroke.

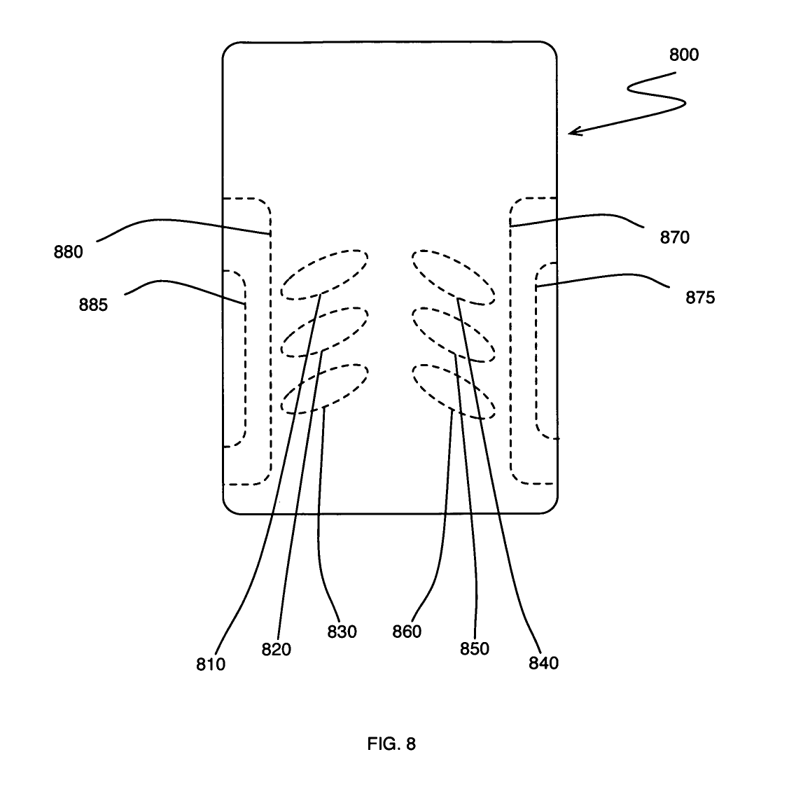

Referring to FIG. 8, possible embodiments may use surfaces capable of detecting multiple touches simultaneously. Some embodiments will not have physical indicators of the preferred location for the touch areas. This allows for easier use of the device in multiple orientations and multiple grasp locations in an orientation. Instead, the invention needs to calibrate the location of L1, L2, L3, R1, R2, and R3 to the user's grasp. The invention has two approaches to accomplish this. Various embodiments can use either approach. One approach to calibrating the grasp of the user recognizes that the user will likely switch between using the primary surface and the secondary surface for input. At the beginning of a transition, the user must touch six fingers to the back of the unit and release them. The invention records the centroids of these locations as the centroids for the six touch locations 810, 820, 830, 840, 850, and 860. After this grasp calibration, touches to the unit will select the zones and then keys as described earlier. The keyboard can block reacting to all touches on the secondary surfaces, or even change its physical appearance to provide feedback to the user, to indicate that a calibration touch is needed.

A second approach to calibration uses sensors 870 and 880 near to the edge of the unit. When the user grasps the unit with their palms, these sensors will be able to detect the extent of the contact 875 and 885. This will allow the system to compute the location of the L1, L2, L3, R1, R2, and R3 locations relative to the palm placements. This approach to calibration uses 875 and 885 to compute the locations for 810, 820, 830, 840, 850, and 860.

In order to compensate for shifts in the user's grip, the invention tracks the location of touches and can adjust these touch locations. If the system detects touches outside of these areas, the invention allows the system to re-enter the calibration process.

Embodiments of the system can combine these approaches. The initial calibration can use both the six finger contact and the palm placement to better estimate the location of the hands and their angle across the back of the unit. The system can then track both the palm positions as the grip drifts over time and track relative locations of touches to detect angular drift over time of the finger position relative to the palm placement.

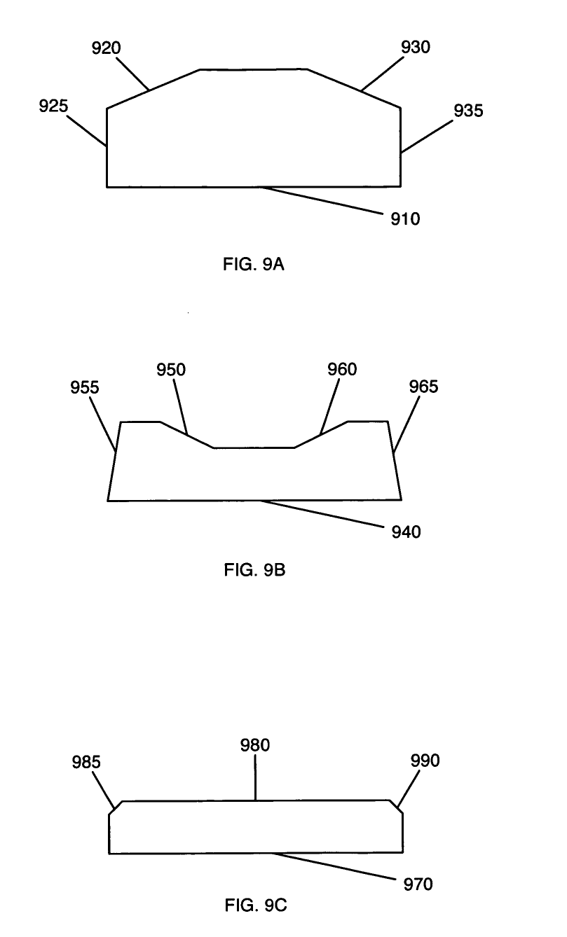

FIGS. 9A, 9B, and 9C show various embodiments for the secondary surfaces described in this invention as seen from a top view looking down at the device with the display element on the surfaces 910, 940, and 970, respectively. In FIG. 9A, embodiments of this invention could use surface 920 for the L1, L2, and L3 touch locations and surface 930 for the R1, R2, and R3 touch locations. Embodiments that are using palm placement calibration may include touch sensors on surfaces 925 and 935. In FIG. 9B, embodiments of this invention could use surface 950 for the L1, L2, and L3 touch locations and surface 960 for the R1, R2, and R3 touch locations. Embodiments that are using palm placement calibration may include touch sensors on surfaces 955 and 965. In FIG. 9C, embodiments of this invention could use surface 980 for the secondary surface touch locations L1, L2, L3, R1, R2, and R3. Embodiments that are using palm placement calibration may include touch sensors on surfaces 980, or use 985 and 995, or both.

Embodiments of the invention may be integrated into an electronic device or be an accessory to an electronic device. When the embodiment is an accessory, the embodiment may communicate with the electronic device via a wired or a wireless mechanism. The accessory may be powered from the electronic device or may have its own power, or may even offer additional power to power both the accessory and the electronic device.

In a typical implementation, touch surface is comprised of a number of sensing elements arranged in a two-dimensional array. Each sensing element (aka, ‘pixel’) generates an output signal indicative of the electric field disturbance (for capacitive sensors), force (for pressure sensors), or optical coupling (for optical sensors) at the sensor element. The ensemble of pixel values at a given time represents a ‘proximity image’. Touch surface controllers provide this data to a processor. The processor, in turn, processes the proximity image information to correlate the user's finger movements across the touch surface.

Various changes in the materials, components, circuit elements, techniques described herein are possible without departing from the scope of the following claims. For instance, illustrative hand-held device 200 may include physical buttons and switches in addition to those described herein for auxiliary functions (e.g., power, mute, reset buttons). In addition, the processor performing the method may be a single computer processor, a special purpose computer processor (e.g., a digital signal processor), a plurality of processors coupled by a communications link or a custom designed state machine. Custom designed state machines may be embodied in hardware devices such as in integrated circuit, including but not limited to application specific integrated circuits (“ASICs”) or field programmable gate arrays (“FPGAs”).

1. A method for operating a handheld device, comprising: displaying a virtual keyboard on a display element on a primary surface of a handheld device when the device is in a specific state; adjusting the presentation of the virtual keyboard on the primary surface based on touches being applied to secondary surfaces, where combinations of touches select different areas within the virtual keyboard.

2. The method of claim 1, wherein six distinct touch areas (L1, L2, L3, R1, R2, and R3) are used to classify touches on secondary surfaces and the combination of touches to these areas, referred to as chords, select different regions of the keyboard.

3. The method of claim 2, whereas the virtual keyboard is logically divided into 3 zones; the touch areas L1 and R1 are used to select which zone is targeted on the virtual keyboard.

4. The method of claim 3, whereas the virtual keyboard provides visual feedback to the user on which zone is being selected based on the state of touch from L1 and R1.

5. The method of claim 3, whereas each zone of a virtual keyboard is logically divided into rows and columns and the touch areas L2 and R2 are used to select which column is targeted within a zone of the virtual keyboard and the touch areas L3 and R3 are used to select which row is targeted within a zone of the virtual keyboard.

6. The method of claim 5, whereas the virtual keyboard provides visual feedback to the user on which row and column are being targeted by the touches to L2, R2, L3, and R3.

7. The method of claim 5, whereas when L1 and R1 are not touches then no zone is selected, the left zone is selected when L1 is touched and R1 is not, the right zone is selected when R1 is touched and L1 is not, and the center zone, if present, is selected when both L1 and R1 are touched.

8. The method of claim 7, whereas when a zone is selected, a column within the zone is selected when L2 and R2 are touched, with various patterns of touch corresponding to specific columns.

9. The method of claim 8, whereas when a zone is selected, a row within the zone is selected when L3 and R3 are touched, with various patterns of touch corresponding to specific rows.

10. The method of claim 9, whereas the virtual keyboard responds to the selection of a zone and also a row and column within a zone as if the user pressed on that area of the key on the primary surface, and when the user releases certain touches on the secondary surfaces, the virtual keyboard responds as if the user had released pressing on the corresponding area on the first surface.

11. The method of claim 8, whereas when a zone is selected and the zone has rows with four items, the column selected when L2 and R2 are not touched is the second column, the column selected when L2 is touched and R2 is not touched is the first, or left, column, the column selected when R2 is touched and L2 is not touched is the fourth, or right, column, touching both L2 and R2 moves the selection to the third column.

12. The method of claim 9, whereas when a zone is selected and the zone has columns with four items, the row selected when L3 and R3 are not touched is the second row, the row selected when L3 is touched and R3 is not touched moves to the top row, the row selected when R3 is touched and L3 is not touched moves to the bottom row, touching both L3 and R3 has both effects, resulting in moving the selection to the third row.

13. The method of claim 8, whereas when a zone is selected and the zone has rows with a maximum of three items, the column selected when L2 and R2 are not touched is the middle column, the column selected when L2 is touched and R2 is not touched moves to the left column, the column selected when R2 is touched and L2 is not touched moves to the right column.

14. The method of claim 9, whereas when a zone is selected and the zone has columns with a maximum of three items, the row selected when L3 and R3 are not touched is the middle row, the row selected when L3 is touched and R3 is not touched moves to the top row, the row selected when R3 is touched and L3 is not touched moves to the bottom row.

15. The method of claim 8, whereas when a zone is selected and the zone has rows with a maximum of two items, no column is selected when L2 and R2 are not touched, the column selected when L2 is touched and R2 is not touched is the left column, the column selected when R2 is touched and L2 is not touched is the right column.

16. The method of claim 9, whereas when a zone is selected and the zone has columns with a maximum of two items, no row is selected when L3 and R3 are not touched, the row selected when L3 is touched and R3 is not touched is the top row, the row selected when R3 is touched and L3 is not touched is the bottom row.

17. The method of claim 2, whereas the touch sensors are not distinct but can sense multiple touches in a region, to allow for grasping the device in more than one position along the edge, and the mapping of touch locations to touch areas adjusts to the position of the grasp.

18. The method of claim 17, whereas the mapping of the touch locations to touch areas is calibrated by sensing 6 simultaneous touches.

19. The method of claim 17, whereas the mapping of touch locations to touch areas is calibrated by sensing the extent two additional areas of touch, the edge areas on the device contacted by the palms of the hands.

20. The method of claim 17, whereas the mapping of the touch locations to touch areas is calibrated by sensing 6 simultaneous touches and is also calibrated by sensing the extent two additional areas of touch, the edge areas on the device contacted by the palms of the hands.

21. The method of claim 17, whereas the mapping of touch locations is adjusted by tracking the drift in the location of sequences of touches to a touch area, allowing the user's grip to drift and the system compensates for this drift without user intervention.

22. The method of claim 2, whereas the mapping of the location of touches to the named touch areas (L1, L2, L3, R1, R2, R3) is user-controlled.

23. An apparatus of an accessory to a handheld electronic device with a display element, comprising: a set of one or more touch surfaces capable of detecting simultaneous touch in at least six locations; a mechanism to physically attach to the handheld electronic device such that the touch sensors are reachable with the fingers while holding the accessory; an electronic interface to the handheld electronic device to communicate the state of the touch sensors to support the processor on the electronic device, a processor of the handheld electronic device with instructions to perform the method in accordance with claim 1.

24. An apparatus of a handheld electronic device comprising: a primary surface having a display element coupled thereto; a set of one or more secondary surfaces having touch sensors coupled thereto, the secondary surfaces not coplanar to the primary surface; the secondary touch surfaces capable of detecting simultaneous touch in at least six locations; a processor of the handheld electronic device with instructions to perform the method in accordance with claim 1.

25. An apparatus of claim 23, wherein the touch sensors are distinct buttons

26. An apparatus of claim 24, wherein the touch sensors are distinct buttons

27. An apparatus of claim 23, wherein the touch sensors are an array of electrical impedance sensors capable of detecting multiple simultaneous touches

28. An apparatus of claim 24, wherein the touch sensors are an array of electrical impedance sensors capable of detecting multiple simultaneous touches

29. An apparatus of claim 23, wherein the device has additional touch sensor locations to support its use in two orientations

30. An apparatus of claim 24, wherein the device has additional touch sensor locations to support its use in two orientations

31. An apparatus of claim 23, wherein the device has additional touch sensor locations to support its use in three orientations

32. An apparatus of claim 24, wherein the device has additional touch sensor locations to support its use in three orientations

33. An apparatus of claim 23, wherein the device has additional touch sensor locations to support its use in four orientations

34. An apparatus of claim 24, wherein the device has additional touch sensor locations to support its use in four orientations

35. An apparatus of claim 27, wherein the accessory or the device has a sensor to detect the orientation of the device that is used to assist in disambiguating touches when touch locations overlap.

36. An apparatus of claim 28, wherein the device has a sensor to detect the orientation of the device that is used to assist in disambiguating touches when touch locations overlap.
